(19) United States
(12) Patent Application Publication
(10) Pub. No.: US 2024/0360711 A1
(43) Pub. Date: Oct. 31, 2024

(54) DUAL-AXIS TORQUE HINGE

(71) Applicant: SUGATSUNE KOGYO CO., LTD., Tokyo (JP)

(72) Inventor: Yuuichi HATANO, Tokyo (JP)

(73) Assignee: SUGATSUNE KOGYO CO., LTD., Tokyo (JP)

(21) Appl. No.: 18/688,516

(22) PCT Filed: Sep. 1, 2022
(86) PCT No.: PCT/JP2022/032895

§ 371 Date: Mar. 1, 2024

(30) Foreign Application Priority Data
Sep. 6, 2021 (JP) 2021-144395

(51) Int. Cl. E05D 11/08; E05D 3/12; F16C 11/04

(52) U.S. Cl. CPC E05D 11/084; E05D 3/12; F16C 11/04

(57) ABSTRACT

Provided is a dual-axis torque hinge capable of moving a first shaft and a second shaft one by one in order. The dual-axis torque hinge includes a plurality of stacked first friction elements (6) which engage with the first shaft (4) and a plurality of stacked second friction elements (7) which engage with the second shaft (5). Each of the first friction elements (6) has an arm (6a) wound around the first shaft (4), and is configured in a manner such that tightening torque at the time of a relative rotation of the first shaft (4) with respect to the first friction element (6) in a tightening direction is greater than loosening torque at the time of the relative rotation of the first shaft (4) with respect to the first friction element (6) in a loosening direction. Each of the second friction elements (7) has an arm (7a), and is configured in a manner such that tightening torque at the time of a relative rotation of the second shaft (5) with respect to the second friction element (7) in a tightening direction is greater than loosening torque at the time of the relative rotation of the second shaft (5) with respect to the second friction element (7) in a loosening direction. When a second main body (2) rotates in one direction relative to a first main body (1), the tightening torque acts on one of the first shaft (4) and the second shaft (5), and the loosening torque acts on the other of the first shaft (4) and the second shaft (5).

### TECHNICAL FIELD

The present invention relates to a dual-axis torque hinge including a first main body, an intermediate body rotatably connected to the first main body about a first shaft, and a second main body rotatably connected to the intermediate body about a second shaft.

### BACKGROUND

Since the dual-axis torque hinge includes two shafts of the first shaft and the second shaft, it is possible to increase an opening angle as compared with a one-axis torque hinge having only one shaft. The applicant proposes a biaxial hinge described in Patent Document 1 as the dual-axis torque hinge.

This dual-axis torque hinge includes a plurality of stacked first friction elements which engage with the first shaft, and a plurality of stacked second friction elements which engage with the second shaft. The first friction elements and the second friction elements are provided to apply torque on the first shaft and the second shaft. By applying the torque on the first shaft and the second shaft, it is possible to maintain any opening angle of the second main body with respect to the first main body, and/or it is possible to reduce impact when the second main body opens and closes with respect to the first main body.

### PRIOR ART DOCUMENT

### Patent Document

Patent Document 1: JP 6556348 B2

### SUMMARY OF THE INVENTION

### Problems to be Solved by the Invention

By the way, in the dual-axis torque hinge, it is requested that the first shaft and the second shaft can be sequentially moved one by one in order to smoothly open and close the second main body.

The present invention has been made in view of the above problem, and provides the dual-axis torque hinge capable of sequentially moving the first shaft and the second shaft one by one in order.

### Means for Solving the Problems

In order to solve the above problem, an aspect of the present invention is a dual-axis torque hinge including a first main body, an intermediate body rotatably connected to the first main body about a first shaft, and a second main body rotatably connected to the intermediate body about a second shaft, the dual-axis torque hinge including:
a plurality of stacked first friction elements which engage with the first shaft; and
a plurality of stacked second friction elements which engage with the second shaft,
wherein each of the first friction elements has an arm wound around the first shaft, and is configured such that tightening torque at the time of a relative rotation of the first shaft with respect to the first friction element in a tightening direction is greater than loosening torque at the time of the relative rotation of the first shaft with respect to the first friction element in a loosening direction,
wherein each of the second friction elements has an arm wound around the second shaft. and is configured such that tightening torque at the time of a relative rotation of the second shaft with respect to the second friction element in a tightening direction is greater than loosening torque at the time of the relative rotation of the second shaft with respect to the second friction element in a loosening direction, and
wherein when the second main body rotates relative to the first main body in one direction, the tightening torque acts on one of the first shaft and the second shaft, and the loosening torque acts on the other of the first shaft and the second shaft.

### Effects of the Invention

According to the present invention, it is possible to sequentially move the first shaft and the second shaft one by one in order using the tightening torque (T1) and the loosening torque (T2) acting simultaneously on the first shaft and the second shaft.

### BRIEF DESCRIPTION OF THE DRAWINGS

FIG. 1 is an external perspective view of a dual-axis torque hinge according to a first embodiment of the present invention.

FIG. 2 is an exploded perspective view of the dual-axis torque hinge of the present embodiment.

FIG. 3 is a longitudinal cross-sectional view of the dual-axis torque hinge of the present embodiment (a cross-sectional view taken along line III-III in FIG. 1).

FIG. 4 is an enlarged view of the intermediate body of FIG. 3.

FIG. 5 is an operation diagram of the dual-axis torque hinge of the present embodiment (FIG. 5(a) shows an opened position, FIG. 5(b) shows a 90° opened position, and FIG. 5(c) shows a closed position).

FIG. 6 is an operation diagram of the dual-axis torque hinge of the present embodiment (FIG. 6(a) shows an opened position, FIG. 6(b) shows a 90° opened position, and FIG. 6(c) shows a closed position).

FIG. 7 is an operation diagram of a conventional two-axis torque hinge (FIG. 7(a) shows an opened position, FIG. 7(b1), (b2) show a 90° opened position, FIG. 7(c) shows a closed position).

FIG. 8 is an exploded perspective view of the dual-axis torque hinge according to a second embodiment of the present invention.

FIG. 9 is an enlarged view of the intermediate body of the dual-axis torque hinge according to the second embodiment of the present invention.

FIG. 10 is an external perspective view of the dual-axis torque hinge according to a third embodiment of the present invention.

FIG. 11 is an exploded perspective view of the dual-axis torque hinge according to the third embodiment of the present invention.

FIG. 12 is an enlarged view of a friction plate according to the third embodiment of the invention.

### MODE FOR CARRYING OUT THE INVENTION

Hereinafter, the dual-axis torque hinge of the present invention will be described in detail based on the accompanying drawings. However, the dual-axis torque hinge of the present invention can be embodied in various forms, and is not limited to the embodiments described herein. These embodiments are provided with an intention of enabling a person skilled in the art to sufficiently understand the invention by making the disclosure of the specification sufficient.

### First Embodiment

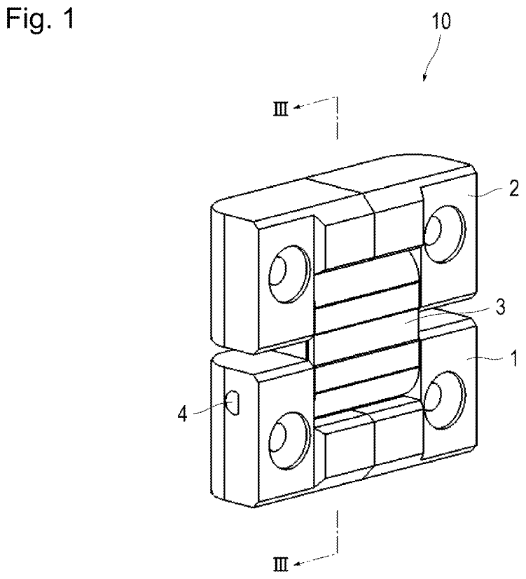

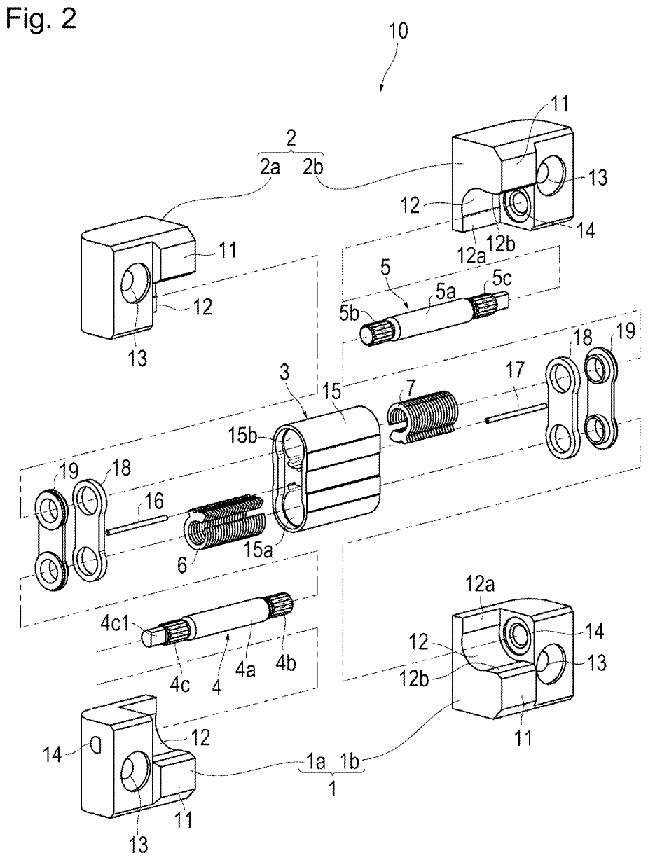

FIG. 1 shows an external perspective view of a dual-axis torque binge 10 according to a first embodiment of the present invention. The dual-axis torque hinge 10 includes a first main body 1, an intermediate body 3, and a second main body 2. The intermediate body 3 is connected to the first main body 1 so as to be rotatable around a first shaft 4 (see FIG. 2). The second main body 2 is connected to the intermediate body 3 so as to be rotatable around a second shaft 5 (see FIG. 2).

The dual-axis torque hinge 10 of the present embodiment is used, for example, to open and close a movable body such as a table, a counter, a door, or a lid of furniture, a vehicle such as a train with respect to a fixed body of the furniture, the vehicle or the like. It is also used to open and close the display of a laptop computer with respect to a main body of the computer. The use of the dual-axis torque hinge 10 of the present embodiment is not limited to these.

FIG. 2 shows an exploded perspective view of the dual-axis torque hinge 10. 1 indicates the first main body, 2 indicates the second main body, 3 indicates the intermediate body, 4 indicates the first shaft, 5 indicates the second shaft, 6 indicates the stacked first friction elements, and 7 indicates the stacked second friction elements.

The first main body 1 includes a pair of first divided bodies 1a and 1b. The first divided bodies la and 1b are formed in a substantially rectangular parallelepiped shape as a whole, and a notch 12 is formed at each of their corners to avoid interference with the intermediate body 3. A through hole 13 through which a tightening member such as a screw for attaching to the fixed body is passed is formed in each of the first divided bodies 1a and 1b.

The first shaft 4 is fixed to the first divided bodies 1a and 1b in a non-rotatable manner. The plurality of stacked first friction elements 6 engage with the first shaft 4. A friction element engagement portion 4a of the first shaft 4 has a substantially circular cross section. At both ends of the first shaft 4 in an axial direction thereof, rotation stop portions 4b and 4c are formed, for example, by knurling. The rotation stop portion 4c is formed with a D-cut portion 4c1 in addition to the knurling. The first divided bodies 1a and 1b are formed with rotation stop holes 14 into which the rotation stop portions 4b and 4c of the first shaft 4 are inserted.

The intermediate body 3 is rotatably supported by the first shaft 4 via the first friction elements 6. The intermediate body 3 is rotatable, for example, within a range of approximately 90° with respect to the first main body 1. The rotation of approximately 90° or more of the intermediate body 3 with respect to the first main body 1 is limited by the intermediate body 3 being in contact with wall surfaces 12a and 12b of the notches 12 of the first main body 1.

The intermediate body 3 includes a housing 15, the first friction elements 6, and the second friction elements 7. The housing 15 is formed to have an elliptical cross section. Housing holes 15a and 15b for housing the first friction elements 6 and the second friction elements 7 are formed in the housing 15. The first friction elements 6 and the second friction elements 7 housed in the housing 15 are fixed to the housing 15 by elastic pins 16 and 17 having a C-shaped cross section. Although the number of the first friction elements 6 and the number of the second friction elements 7 is equal to each other, these numbers can also be different from each other. The shapes and arrangements of the first friction elements 6 and the second friction elements 7 will be described later.

Lids 18 and lids 19 having holes through which the first shaft 4 and the second shaft 5 penetrate are attached to both ends of the intermediate body 3 in the axial direction. The lids 18 are made of metal. and the lids 19 are made of resin. The lids 19 are provided to prevent contact between metals.

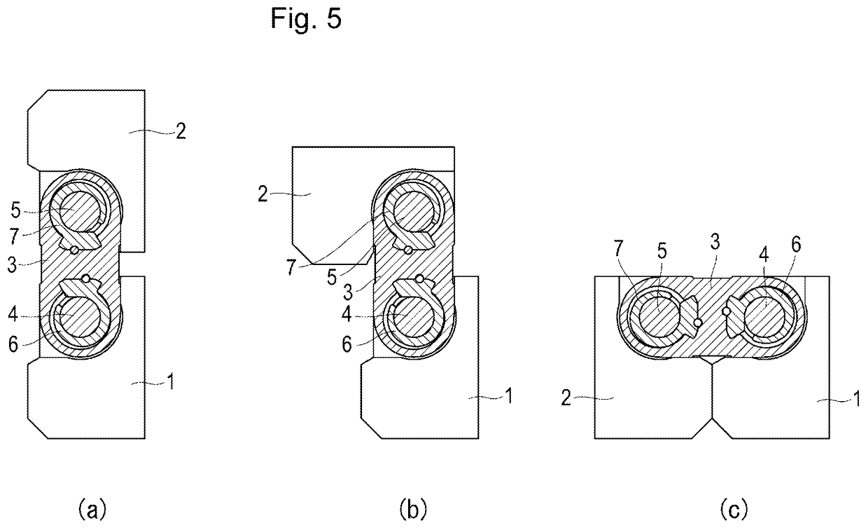

The second main body 2 is also divided into two parts and includes a pair of second divided bodies 2a and 2b. The second divided body 2a has substantially the same shape as the first divided body 1b. The second divided body 2b has substantially the same shape as the first divided body 1a. The first divided bodies 1a, 1b and the second divided bodies 2a, 2b are formed with stoppers 11 that are in contact with each other and determine a closed position (see FIG. 5(c)) of the dual-axis torque hinge 10.

The second shaft 5 is fixed to the second divided bodies 2a and 2b in a non-rotatable manner. The second shaft 5 is substantially parallel to the first shaft 4. The plurality of stacked second friction elements 7 engage with the second shaft 5. A friction element engagement portion 5a of the second shaft 5 has a substantially circular cross section. The second shaft 5 has substantially the same shape as the first shaft 4. Rotation stop portions 5b and 5c are formed at both ends of the second shaft 5 in the axial direction. The first shaft 4 and the second shaft 5 are not connected by a link. The first shaft 4 and the second shaft 5 are freely rotatable relative to each other.

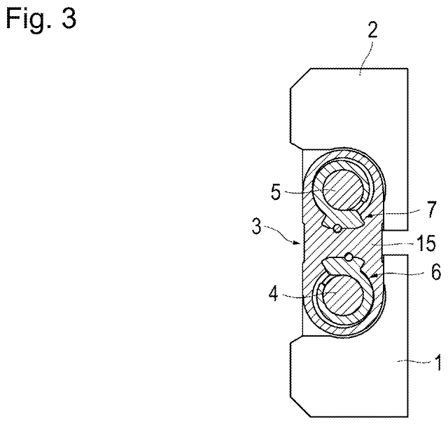

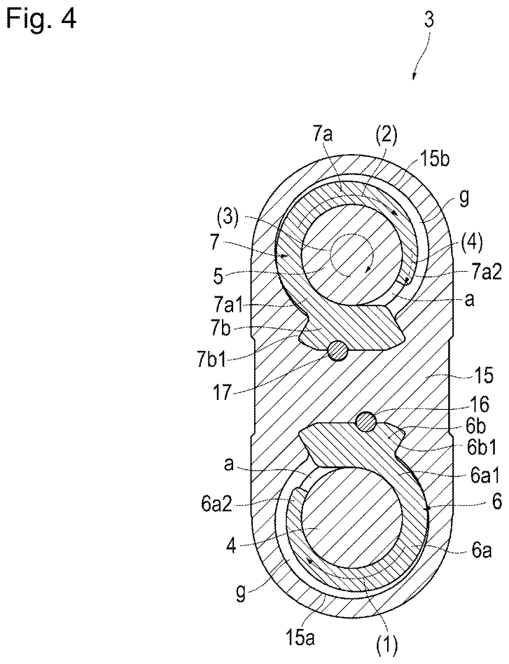

FIG. 3 shows a longitudinal cross-sectional view of the dual-axis torque hinge 10 of the present embodiment. FIG. 4 shows an enlarged view of the intermediate body 3 of FIG. 3. As shown in FIG. 4, each of the first friction elements 6 includes a connecting portion 6b and an arm 6a. The connecting portion 6b is formed in a substantially trapezoidal shape. The arm 6a has a base portion 6a1 and a tip portion 6a2 and is wound around the first shaft 4. The base portion 6a1 of the arm 6a is integrally formed on the right side of the connecting portion 6b. The arm 6a is curved in an arc shape from the base portion 6a1 to the tip portion 6a2. An opening a is formed between the tip portion 6a2 and the left side of the connecting portion 6b. A winding direction from the base portion 6a1 of the arm 6a toward the tip portion 6a2 is the clockwise direction (the direction (1) in FIG. 4).

When the arm 6a is in a relaxed state, a diameter of an inner surface of the arm 6a is smaller than a diameter of an outer surface of the first shaft 4. Therefore, the arm 6a frictionally engages with the surface of the first shaft 4 and exerts radial compression to the first shaft 4.

In a preferred embodiment, a radial thickness of the tip portion 6a2 of the arm 6a is thinner than a radial thickness of the base portion 6a1. The radial thickness of the tip portion 6a2 is thicker than a thickness of the first friction element 6 in the axial direction.

A cross section of the housing hole 15a of the housing 15 substantially matches an outer surface of the first friction element 6. At the position of the arm 6a of the first friction element 6, a gap g is formed between an inner surface of the housing hole 15a and the outer surface of the first friction element 6. At the position of the connecting portion 6b, an inclined surface 6b1 of the connecting portion 6b and an inclined inner surface of the housing hole 15a are in direct contact by the elastic pin 16.

Similarly to the first friction element 6, each of the second friction elements 7 includes a connecting portion 7b and an arm 7a. The arm 7a has a base portion 7a1 and a tip portion 7a2 and is wound around the second shaft 5. The base portion 7a1 of the arm 7a is integrally formed on the left side of the connecting portion 7b. The arm 7a is curved in an arc shape from the base portion 7a1 to the tip portion 7a2. An opening a is formed between the tip portion 7a2 of the arm 7a and the right side of the connecting portion 7b. A winding direction from the base portion 7a1 of the arm 7a toward the tip portion 7a2 is the clockwise direction (the direction (2) in FIG. 4). The winding direction of the arm 7a and the winding direction of the arm 6a are the same direction (clockwise direction). When the first friction element 6 rotates by approximately 180°, the first friction element 6 overlaps the second friction element 7.

A cross section of the housing hole 15b of the housing 15 substantially matches an outer surface of the second friction element 7. At the position of the arm 7a of the second friction element 7, a gap g is formed between an inner surface of the housing hole 15b and the outer surface of the second friction element 7. At the position of the connecting portion 7b, an inclined surface 7b1 of the connecting portion 7b and an inclined inner surface of the housing hole 15b are in direct contact by the elastic pin 17.

In the present embodiment, tightening torque T1 at the time of a relative rotation of the first shaft 4 and a relative rotation of the second shaft 5 in a tightening direction is different from loosening torque T2 at the time of a relative rotation of the first shaft 4 and a relative rotation of the second shaft 5 in a loosening direction. This will be described below.

As shown in FIG. 4, when the second shaft 5 rotates relative to the second friction element 7 in the tightening direction (3) (clockwise direction), the tip portion 7a2 of the arm 7a is pulled downward as indicated by the broken line (4) in FIG. 4 due to the friction with the second shaft 5, causing the arm 7a to tighten the second shaft 5. For this reason, the large torque T1 acts on the second shaft 5.

When the second shaft 5 rotates in the loosening direction (direction opposite to (3) in FIG. 4), the tip portion 7a2 of the arm 7a is pulled upward opposite to the broken line (4), and the tip portion 7a2 is unable to compress the second shaft 5 and deforms outward. For this reason, the small torque T2 (T2<T1) acts on the second shaft 5.

Similarly, when the first shaft 4 rotates in the tightening direction relative to the first friction element 6, the large torque T1 acts on the first shaft 4. and when the first shaft 4 rotates in the loosening direction, the small torque T2 (T2<T1) acts on the first shaft 4.

Further, in the present embodiment, when the loosening torque T2 acts on one of the first shaft 4 and the second shaft 5, the tightening torque T1 acts on the other of the first shaft 4 and the second shaft 5. This will be described below.

FIG. 5 shows an operation diagram of the dual-axis torque hinge 10 when the second main body 2 rotates from an opened position to a closed position with respect to the first main body 1. FIG. 5(a) shows a 180° opened position, FIG. 5(b) shows a 90° opened position, and FIG. 5(c) shows a closed position.

When the second main body 2 in the opened position shown in FIG. 5(a) rotates in the closing direction, the second shaft 5 attempts to rotate together with the second main body 2, so that the torque T2 in the loosening direction acts on the second shaft 5. At this time, since the first friction element 6 attempts to rotate together with the intermediate body 3, the torque T1 in the tightening direction acts on the first shaft 4. Therefore, only the second shaft 5 rotates relative to the second friction element 7, and the second main body 2 rotates to the 90° opened position shown in FIG. 5 (b) with respect to the intermediate body 3.

Once the second main body 2 rotates to the 90° opened position shown in FIG. 5(b), the second main body 2 and the intermediate body 3 come into contact with each other to limit the relative rotation of the second shaft 5. Once the second main body 2 further rotates in the closing direction, the first shaft 4 rotates relative to the first friction element 6, and the second main body 2 and the intermediate body 3 rotate to the closed position shown in FIG. 5(c). In this regard, the rotation of the first shaft 4 with respect to the first friction element 6 is relative. Thus, the first friction element 6 actually rotates relative to the first shaft 4 fixed to the first main body 1.

As described above, when the second main body 2 is opened with respect to the first main body 1, the first shaft 4 and the second shaft 5 can be sequentially moved one by one in order using the tightening torque T1 and the loosening torque T2 simultaneously acting on the first shaft 4 and the second shaft 5.

When the second main body 2 in the closed position in FIG. 5(c) rotates in the opening direction, the torque T1 in the tightening direction acts on the second shaft 5, and the torque T2 in the loosening direction acts on the first shaft 4. Therefore, the first shaft 4 rotates relative to the first friction element 6, and the second main body 2 and the intermediate body 3 rotate to the 90° opened position shown in FIG. 5(b) with respect to the first main body 1. Once the intermediate body 3 rotates to the 90° opened position shown in FIG. 5(b), the intermediate body 3 and the first main body 1 come into contact with each other to limit the relative rotation of the first shaft 4.

Once the second main body 2 further rotates in the opening direction, the second shaft 5 rotates relative to the second friction element 7, and the second main body 2 rotates to the opened position shown in FIG. 5(a) with respect to the intermediate body 3.

As described above, even when the second main body 2 is closed with respect to the first main body 1, the first shaft 4 and the second shaft 5 can be sequentially moved one by one in order by using the tightening torque T1 and the loosening torque T2 simultaneously acting on the first shaft 4 and the second shaft 5.

Further, according to the dual-axis torque hinge 10 of the present embodiment, the movement of the second main body 2 can also be made the same between when the second main body 2 is opened and when the second main body 2 is closed. This will be described below.

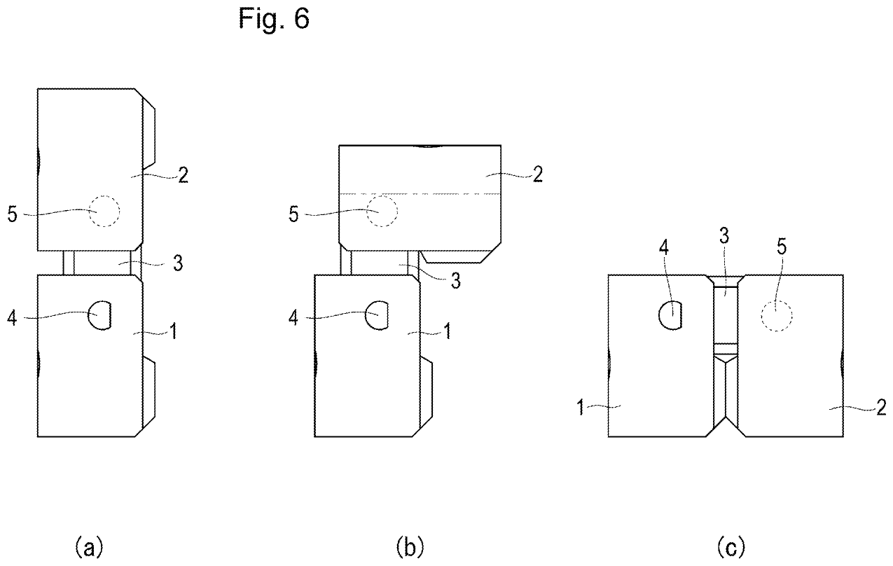

FIG. 6 shows an operation diagram of the dual-axis torque hinge 10 of the present embodiment. FIG. 6 shows the dual-axis torque hinge 10 from the opposite direction to FIG. 5. The operation diagram of FIG. 5 and the operation diagram of FIG. 6 are substantially the same.

As described above, once the second main body 2 in the opened position shown in FIG. 6(a) is closed, the second main body 2 and the intermediate body 3 reach the closed position shown in FIG. 6(c) via the 90° opened position shown in FIG. 6(b). Once the second main body 2 in the closed position shown in FIG. 6(c) is opened, the second main body 2 and the intermediate body 3 reach the opened position shown in FIG. 6(a) via the 90° opened position shown in FIG. 6(b). Postures of the second main body 2 and the intermediate body 3 at the 90° opened position shown in FIG. 6 (b) are the same between when the second main body 2 is closed and when the second main body 2 is opened.

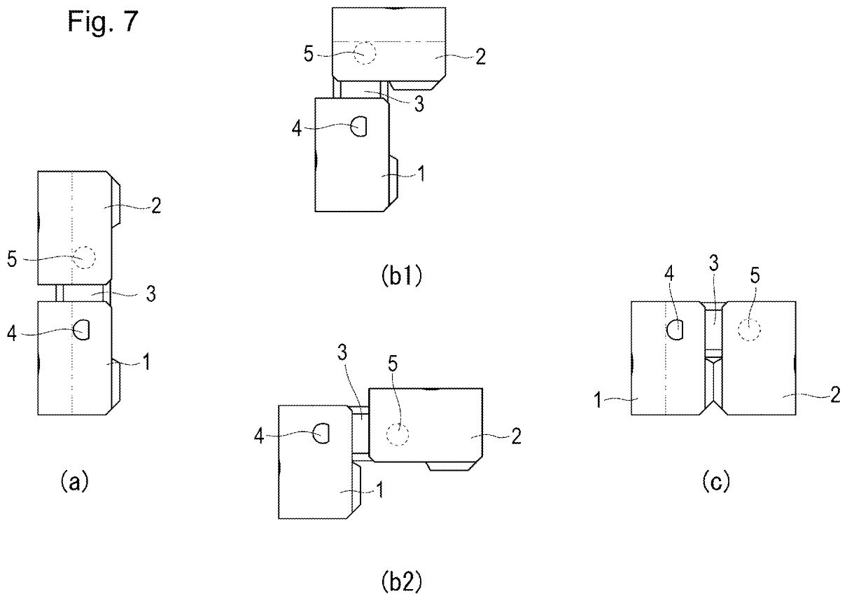

FIG. 7 shows an operation diagram of a conventional two-axis torque hinge described in Patent Document 1. In the conventional torque hinge, the torque acting on the first shaft 4 is made different from the torque acting on the second shaft 5. However. the first friction element 6 and the second friction element 7 are formed in a ring shape, and the tightening torque T1 and the loosening torque T2 are equal. Therefore, once the second main body 2 in the opened position shown in FIG. 7(a) is closed, the second main body 2 and the intermediate body 3 reach the closed position shown in FIG. 7(c) via the 90° opened position shown in FIG. 7(b1). Once the second main body 2 in the closed position shown in FIG. 7(c) is opened, the second main body 2 and the intermediate body 3 reach the opened position shown in FIG. 7(a) via the 90° opened position shown in FIG. 7(b2). At the 90° opened positions shown in FIG. 7(b1) and FIG. 7(b2), the postures of the second main body 2 and the intermediate body 3 are different between when the second main body 2 is closed and when the second main body 2 is opened.

### Second Embodiment

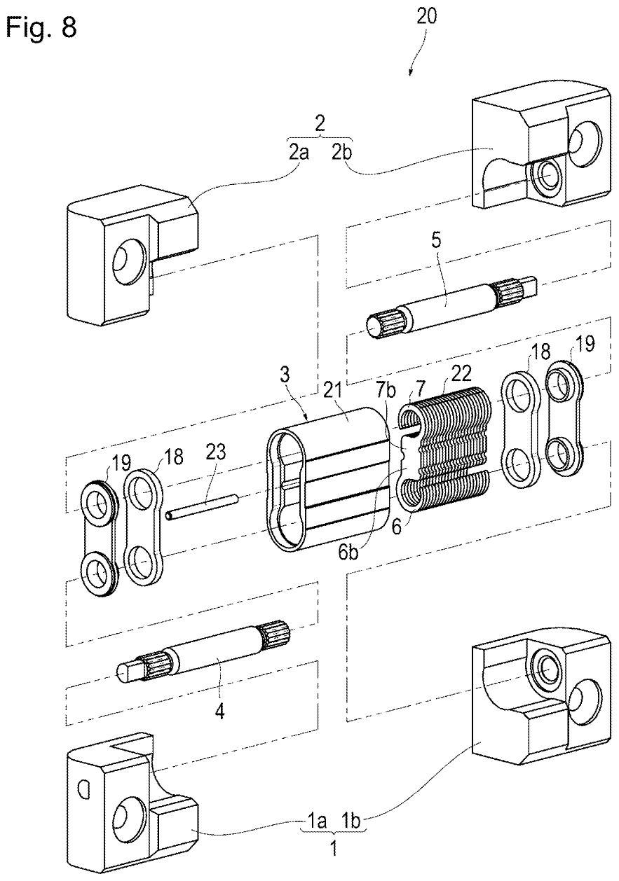

FIG. 8 shows an exploded perspective view of a dual-axis torque hinge 20 according to a second embodiment of the present invention. 1 indicates the first main body, 3 indicates the intermediate body. 2 indicates the second main body, 4 indicates the first shaft, and 5 indicates the second shaft. The configurations of the first main body 1, the second main body 2, the first shaft 4, and the second shaft 5 are the same as those of the dual-axis torque hinge 10 of the first embodiment. Thus, the same reference numerals are given and the descriptions thereof will be omitted.

In the dual-axis torque hinge 10 of the first embodiment. the first friction element 6 and the second friction element 7 are separately formed, whereas in the dual-axis torque hinge 20 of the second embodiment, the first friction element 6 and the second friction element 7 are integrally formed. That is, the intermediate body 3 includes a friction plate 22 in which the first friction element 6 and the second friction element 7 are integrated.

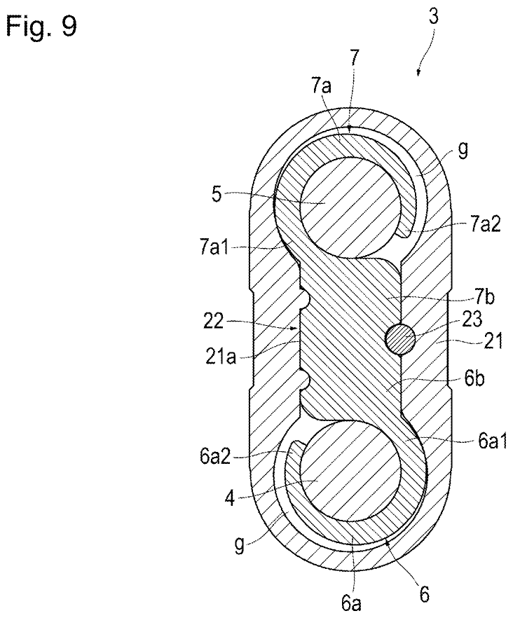

As shown in FIG. 9, the first friction element 6 has an arm 6a, and is configured such that the tightening torque at the time of the relative rotation of the first shaft 4 with respect to the first friction element 6 in the tightening direction is greater than the loosening torque at the time of the relative rotation of the first shaft 4 with respect to the first friction element 6 in the loosening direction. The arm 6a has a base portion 6a1 and a tip portion 6a2 and is wound around the first shaft 4. The base portion 6a1 of the arm is integrally formed on the right side of the connecting portion 6b. The arm 6a is curved in an arc shape from the base portion 6a1 to the tip portion 6a2.

The second friction element 7 has an arm 7a and is configured such that the tightening torque at the time of the relative rotation of the second shaft 5 with respect to the second friction element 7 in the tightening direction is greater than the loosening torque at the time of the relative rotation of the second shaft 5 with respect to the second friction element 7 in the loosening direction. The arm 7a has a base portion 7a1 and a tip portion 7a2 and is wound around the second shaft 5. The base portion 7a1 of the arm 7a is integrally formed on the left side of the connecting portion 7b. The arm 7a is curved in an are shape from the base portion 7a1 to the tip portion 7a2. A winding direction from the base portion 7a1 of the arm 7a toward the tip portion 7a2 is the same as a winding direction from the base portion 6a1 of the arm 6a toward the tip portion 6a2.

A housing hole 21a for housing the friction plate 22 is formed in the housing 21 of the intermediate body 3. A cross-sectional shape of the housing hole 21a substantially matches an outer surface of the friction plate 22. The friction plate 22 is fixed to the housing 21 by an elastic pin 23. At the positions of the arms 6a and 7a, gaps g are created between an inner surface of the housing hole 21a and the outer surfaces of the arms 6a and 7a.

The dual-axis torque hinge 20 of the second embodiment exhibits the same effect as the dual-axis torque hinge 10 of the first embodiment.

### Third Embodiment

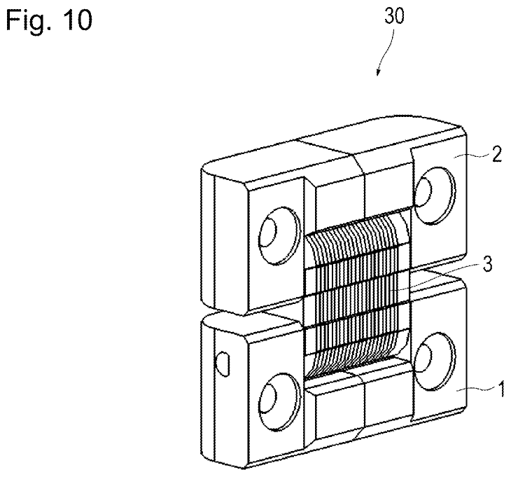

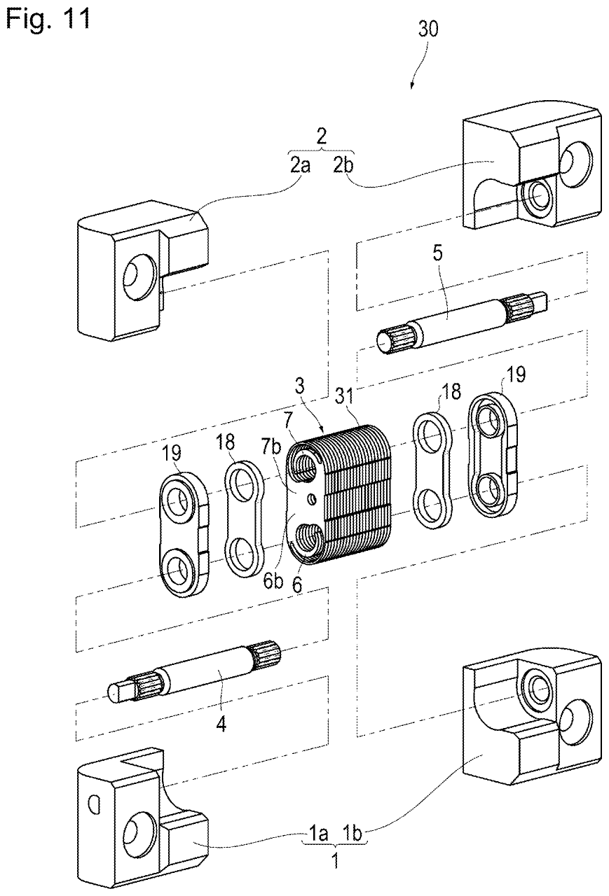

FIG. 10 shows an external perspective view of a dual-axis torque hinge 30 according to a third embodiment of the present invention. FIG. 11 shows an exploded perspective view of the dual-axis torque hinge 30. 1 indicates the first main body. 3 indicates the intermediate body, 2 indicates the second main body, 4 indicates the first shaft, and 5 indicates the second shaft. The configurations of the first main body 1. the second main body 2, the first shaft 4, and the second shaft 5 are the same as those of the dual-axis torque hinge 10 of the first embodiment. For this reason, the same reference numerals are given and the descriptions thereof will be omitted.

In the dual-axis torque hinge 30 of the third embodiment, the first friction element 6 and the second friction element 7 are integrally formed. That is, the intermediate body 3 includes a friction plate 31 in which the first friction element 6 and the second friction element 7 are integrated. The friction plate 31 is exposed without being covered by a housing.

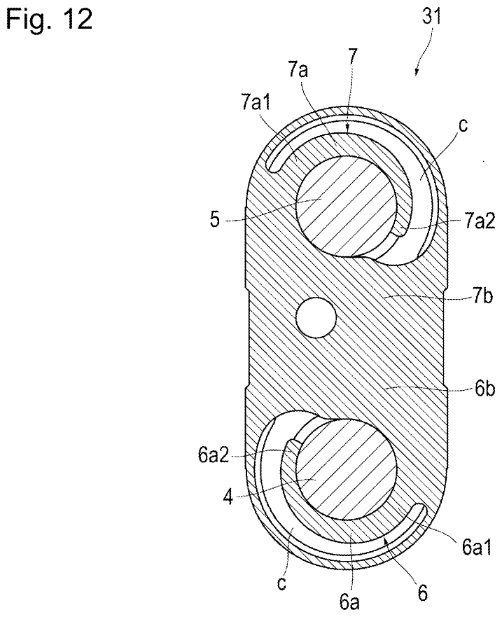

As shown in FIG. 12, the first friction element 6 has an arm 6a, and is configured such that the tightening torque at the time of the relative rotation of the first shaft 4 with respect to the first friction element 6 in the tightening direction is greater than the loosening torque at the time of the relative rotation of the first shaft 4 with respect to the first friction element 6 in the loosening direction. The arm 6a is formed by making an arc-shaped notch c in the friction plate 31. The arm 6a has a base portion 6a1 and a tip portion 6a2 and is wound around the first shaft 4. The base portion 6a1 of the arm 6a is integrally formed on the right side of the connecting portion 6b. The arm 6a is curved in an are shape from the base portion 6a1 to the tip portion 6a2.

The second friction element 7 has an arm 7a and is configured such that the tightening torque at the time of the relative rotation of the second shaft 5 with respect to the second friction element 7 in the tightening direction is greater than the loosening torque at the time of the relative rotation of the second shaft 5 with respect to the second friction element 7 in the loosening direction. The arm 7a is also formed by making an arc-shaped notch c in the friction plate 31. The arm 7a has a base portion 7a1 and a tip portion 7a2 and is wound around the second shaft 5. The base portion 7a1 of the arm 7a is integrally formed on the left side of the connecting portion 7b. The arm 7a is curved in an arc shape from the base portion 7a1 to the tip portion 7a2. A winding direction from the base portion 7a1 of the arm 7a toward the tip portion 7a2 is the same as a winding direction from the base portion 6a1 of the arm 6a toward the tip portion 6a2.

The dual-axis torque hinge 30 of the third embodiment exhibits the same effect as the dual-axis torque hinge 10 of the first embodiment.

It should be noted that the present invention is not limited to being embodied in the above-described embodiments, and can be modified into various embodiments without changing the gist of the present invention.

In the above embodiments, the first shaft and the second shaft are respectively fixed to the first main body and the second main body, and the first friction element and the second friction element are fixed to the intermediate body. However, the first shaft and the second shaft can be fixed to the intermediate body, and the first friction element and the second friction element can be fixed to the first main body and the second main body, respectively.

In addition, the first shaft can be fixed to the first main body. the first friction element can be fixed to the intermediate body, the second shaft can be fixed to the intermediate body, and the second friction element can be fixed to the second main body. Furthermore, the first shaft can be fixed to the intermediate body, the first friction element can be fixed to the first main body, the second shaft can be fixed to the second main body, and the second friction element can be fixed to the intermediate body.

In the above-described embodiments, although each of the first friction element and the second friction element has one arm, each of the first friction element and the second friction element may have long and short arms extending from the connecting portion in opposite directions from each other.

The present specification is based on Japanese Patent Application No. 2021-144395 filed on Sep. 6, 2021. All these contents are included here.

### EXPLANATION OF REFERENCE NUMERALS

1: first main body
2: second main body
3: intermediate body
4: first shaft
4a: friction element engagement portion
5: second shaft
5a: friction element engagement portion
6: first friction element
6a: arm
6a1: base portion
6a2 tip portion
6b: connecting portion
7: second friction element
7a: arm
7a1: base portion
7a2: tip portion
7b: connecting portion
10: dual-axis torque hinge
15: housing hole
20: dual-axial torque hinge
21: housing
30: dual-axis torque hinge

1. A dual-axis torque hinge comprising a first main body, an intermediate body rotatably connected to the first main body about a first shaft, and a second main body rotatably connected to the intermediate body about a second shaft, the dual-axis torque hinge comprising:
a plurality of stacked first friction elements which engage with the first shaft; and
a plurality of stacked second friction elements which engage with the second shaft,
wherein each of the first friction elements has an arm wound around the first shaft, and is configured such that tightening torque at the time of a relative rotation of the first shaft with respect to the first friction element in a tightening direction is greater than loosening torque at the time of the relative rotation of the first shaft with respect to the first friction element in a loosening direction,
wherein each of the second friction elements has an arm wound around the second shaft, and is configured such that tightening torque at the time of a relative rotation of the second shaft with respect to the second friction element in a tightening direction is greater than loosening torque at the time of the relative rotation of the second shaft with respect to the second friction element in a loosening direction, and
wherein when the second main body rotates relative to the first main body in one direction, the tightening torque acts on one of the first shaft and the second shaft, and the loosening torque acts on the other of the first shaft and the second shaft.

2. The dual-axis torque hinge according to claim 1, wherein when the second main body rotates relative to the first main body in one direction, the one of the first shaft and the second shaft performs the relative rotation, and wherein after the relative rotation of the one of the first shaft and the second shaft is limited, the other of the first shaft and the second shaft performs the relative rotation.

3. The dual-axis torque hinge according to claim 1, wherein each of friction element engagement portions of the first shaft and the second shaft has a substantially circular cross section.

4. The dual-axis torque hinge according to claim 1, wherein the first friction element and the second friction element are provided in the intermediate body, and
wherein a winding direction of the arm of the first friction element is the same as a winding direction of the arm of the second friction element.

5. The dual-axis torque hinge according to claim 4, wherein the first friction element and the second friction element are housed in a housing of the intermediate body.

6. The dual-axis torque hinge according to claim 4, wherein the first friction element and the second friction element are integrally formed.
